(19) United States
(12) Patent Application Publication
(10) Pub. No.: US 2004/0044557 A1
(43) Pub. Date: Mar. 4, 2004

(54) Supply chain logistics model and method of educating workshop participants in supply chain logistics management

(76) Inventors: Steven Jon Frech, Kennesaw, GA (US); Foster Paul Piciacchia, Knoxville, TN (US)

Correspondence Address: Schwartz Law Firm, P.C., SouthPark Towers, Suite 530, 6100 Fairview Road, Charlotte, NC, 28210, US

(21) Appl. No.: 10/461,716

(22) Filed: Jun. 13, 2003

Related U.S. Application Data
(60) Provisional application No. 60/388,864, filed on Jun. 14, 2002.

(51) Int. Cl. G06F 17/60

(52) U.S. Cl. 705/8; 705/1

(57) ABSTRACT

A supply chain logistics model is adapted to educate and train a number of workshop participants in supply chain logistics through interactive role-playing carried out in a simulated supply chain system. The model includes a notional, predefined geographic region where product is manufactured and distributed. Workshop participants role-play a notional customer, manufacturer, and distributor all located within the geographic region. The customer initiates at least one product order cycle in the supply chain system. The manufacturer assembles raw components to create product ordered by the customer. The distributor transports the assembled product from the manufacturer to the customer. Transportation time is simulated based on a predefined time and distance scale. A timer is provided for calculating order cycle delivery time beginning from placement of the product order to receipt by the customer of the assembled product.

### TECHNICAL FIELD AND BACKGROUND OF THE INVENTION

This invention relates to a supply chain logistics simulation model, and method of training workshop participants in supply chain logistics management. “Supply chain logistics” is defined by the Council of Logistics Management as the process of planning, implementing, and controlling the efficient, effective flow and storage of goods, services, and related information from the point of origin to point of consumption for the purpose of conforming to customer requirements. The purpose of the invention is to provide macro level education and training for supply chain logistics management that is focused on lean enterprise concepts using a live simulation model and interactive workshop approach. The model provides a platform for participants to view and execute an operating supply chain enterprise from an integrated macro perspective encompassing suppliers, consolidators, manufacturing plants, distribution, warehousing, transportation, and customers within a classroom training environment.

The workshop provides both lecture and hands on supply chain logistics model training to test new concepts and variables using design-of-experiment (DOE) techniques that focus on improving and optimizing the lean enterprise supply chain system.

Workshop concepts and variables include:

Lean enterprise wide integration (macro perspective)

Supplier network

Outsourcing and consolidation operations

Lean production manufacturing systems

Distribution warehousing systems

Acquisition and consolidation of manufacturing plants

Information systems/e-commerce/B-to-B information

Customer fulfillment and satisfaction

Preferably, the model includes a work team of at least 15 individuals who will supply, manufacture, transport, warehouse, distribute and ship products to the customer in a simulated supply chain geographic region. Simulated support functions are included for: Demand Forecasting, Customer Order Entry, Production Planning, Manufacturing Execution, Just-In-Time Delivery, Transportation Planning, Supplier Integration, and Information Processing. The invention uses gaming boards, raw materials, components, equipment, and supply chain entity functions common to most supply chain logistics environments. The invention practices the concepts of supply chain optimization as the work team collaborates to implement various suggestions and ideas executed through various supply chain workshop simulations.

Sub-Optimized Versus Optimized Supply Chain Enterprises

The comparison of these two manufacturing, distribution, and supply chain styles is quite dynamic and can have a dramatic impact on strategy, concepts, techniques and implementation for supply chain logistics for any organization considering changing to this type of operating style in the future. By establishing the key supply chain values that drive supply chain strategy, numerous process changes are made to all aspects of supply chain operations, internally and externally. In turn, as each process change is enacted, the culture of the entire supply chain enterprise arrangement and execution experiences a change in the way it functions, organizationally and culturally. These three dynamic change agents; Values, Processes, and Culture, form the basis for executing dynamic supply chain integration and operations through each of the workshop's designed and controlled experiments.

The simulation model and workshop of the present invention puts supply chain enterprise concepts into a practical demonstration to teach individuals and organizations how these concepts work. Participants in the workshop will observe the interactions of an entire working supply chain from a functional perspective. The invention focuses on concepts of Supply Chain Management, Lean Enterprise Management, and Just-In-Time Management. Hands-on, live model simulations will reinforce supply chain logistics theories, concepts, and methods that can have a dramatic influence on an organization's competitiveness, profitability, and performance. More importantly, the invention is a step toward the way in which most lean enterprise organizations must begin to think, change and react in order to be globally competitive in the 21st century.

### SUMMARY OF INVENTION

Therefore, it is an object of the invention to provide a hands-on workshop focused on supply chain logistics optimization using a “live” simulation model that combines working physical game components with computers and software.

It is another object of the invention to provide a simulation model and workshop which uses gaming boards, raw materials, components, equipment, information technology, supply chain entity functions and financial analysis common to most supply chain logistics environments.

It is another object of the invention to provide a simulation model and workshop enlists a team of participants who assume supply chain roles and manufacture, transport, house, distribute and ship products to the customer in a simulated supply chain.

It is another object of the invention to provide a simulation model and workshop which offers participants a high-level view of the strategic, operational and performance differences between traditional make-and-stock-to-forecast (Push) supply chain systems and customer-driven (Pull) supply chain systems.

It is another object of the invention to provide a simulation model and workshop which offers participants an awareness of progressive industry trends and best practices in supply chain logistics.

It is another object of the invention to provide a simulation model and workshop wherein participants learn how to balance the physical, operational and financial tradeoffs involved in optimizing a supply chain logistics system.

It is another object of the invention to provide a simulation model and workshop which incorporates a supply chain logistics financial model which will allow the workshop participants to analyze the impact to customer delivery performance, the enterprise's financial position, and the costs across the entire supply chain resulting from changes in both the operating and physical aspects of the supply chain.

It is another object of the invention to provide a simulation model and workshop wherein participants acquire insight into how increasing demand and lead time variability impacts traditional supply chain logistics systems.

It is another object of the invention to provide a simulation model and workshop which provides 360-degree vision into the strategic, operational and performance differences between “Push” and “Pull” supply chain logistics systems.

It is another object of the invention to provide a simulation model and workshop wherein participants gain an awareness of the shift in best practices from “Push” to “Pull” supply chain logistics and the reasons for the shift.

These and other objects of the present invention are achieved in the preferred embodiments disclosed below by providing a supply chain logistics model adapted to educate and train a number of workshop participants in supply chain logistics through interactive role-playing carried out in a simulated supply chain system. The model includes a notional, predefined geographic region where product is manufactured and distributed. A first workshop participant role-plays a notional customer located within the geographic region. The customer initiates at least one product order cycle in the supply chain system. A second workshop participant role-plays a notional manufacturer who assembles raw components to create product ordered by the customer. The manufacturer is located a predefined distance from the customer within the geographic region. A third workshop participant role-plays a notional distributor who transports the assembled product from the manufacturer to the customer. Transportation time is simulated based on a predefined time and distance scale. A timer is provided for calculating order cycle delivery time beginning from placement of the product order to receipt by the customer of the assembled product.

According to another preferred embodiment, customer orders are created randomly by spinning a customer order entry gauge to determine the quantity and type of product ordered.

According to another preferred embodiment, the notional geographic region is divided into a plurality of notional sub-regions.

According to another preferred embodiment, fourth and fifth workshop participants role-play respective notional sales managers for the sub-regions.

According to another preferred embodiment, each of the sales managers is responsible for accepting customer orders and scheduling product distribution.

According to another preferred embodiment, a sixth workshop participant role-plays a notional distribution warehouse manager who manages a notional distribution warehouse.

According to another preferred embodiment, the distribution warehouse manager is responsible for ensuring sufficient quantity of finished good product in the distribution warehouse.

According to another preferred embodiment, the manufacturer is a notional plant manager who manages a notional product manufacturing plant.

According to another preferred embodiment, the plant manager is responsible for obtaining raw components to assemble product, and for requesting transportation services from the distributor.

According to another preferred embodiment, a seventh workshop participant role-plays a notional supplier who supplies raw components to the manufacturing plant.

According to another preferred embodiment, an eighth workshop participant role-plays a notional consolidator who creates part kits for delivery downstream to the manufacturing plant.

According to another preferred embodiment, the distributor is a notional truck driver who delivers finished product from the manufacturing plant to the customer.

According to another preferred embodiment, a ninth workshop participant role-plays another notional truck driver who delivers raw components from the supplier to the manufacturing plant.

According to another preferred embodiment, a tenth workshop participant role-plays yet another notional truck drive who delivers part kits from the consolidator to the manufacturing plant.

According to another preferred embodiment, a supply chain logistics financial model is used for collecting and analyzing data to determine performance results of the simulated order cycle across the entire supply chain system.

In another embodiment, the invention is a method of educating and training a number of workshop participants in supply chain logistics through interactive role-playing carried out in a simulated supply chain system.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a graphic illustration showing the multi-tiered structure of the SCL Model;

FIG. 2 is a graphic illustration showing the supply chain environment of a “Push” simulation;

FIG. 3 shows the components and assembly of various widgets used in the SCL Model;

FIG. 4 is a graphic illustration of an “Optimized” supply chain integration simulation;

FIG. 5 is a plan view of the simulated geographic area called “Widget Land”;

FIG. 6 is a plan view of Widget Land showing the location of customers, distribution warehouses, manufacturing plants, and suppliers, and movement of the Red Truck Line and the Blue Truck Line throughout the region;

FIG. 7 includes the corporate production plan for each plant in a base case simulation;

FIG. 8 illustrates a sample model game board; and

FIG. 9 is a sample simulated information transaction screen used in the model simulation.

### DESCRIPTION OF THE PREFERRED EMBODIMENT AND BEST MODE

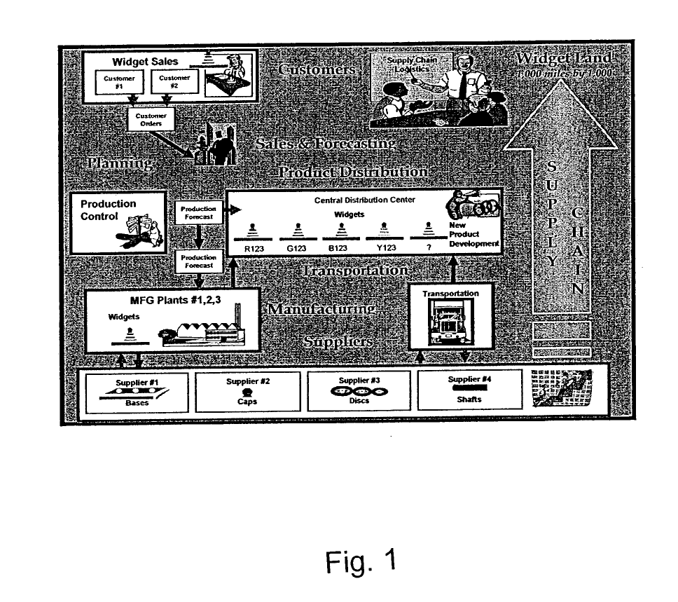

Referring now specifically to the drawings, the basic structure of a supply chain logistics model (“SCL Model”) according to the present invention is illustrated in the graphic diagram of FIG. 1. The SCL Model operates in a notional geographic region called “Widget Land” where a company, “Widget, Inc.”, manufactures, sells, and transports “Widgets” to Customers. The SCL Model encompasses a multi-tiered structure that includes:

Suppliers

Consolidators and Outsourcing

Manufacturing Plants

Transportation

Distribution Warehousing

Sales Regions and Customers

The goal of the workshop is to develop concepts that fully integrate the supply chain in a mutually beneficial way for all supply chain partners that result in value added services for the ultimate customer in the supply chain. All activities and functions are directed toward total customer satisfaction and fulfillment in a value stream focused on the customer.

Requirements that enhance customer satisfaction include:

Shorter Delivery Cycles

Lower Delivered Cost for goods and services

Improved Supply Chain Communications

Sustainable Long Term Efficiencies

Strategic Positioning Incentives

The Supply Chain Base Case

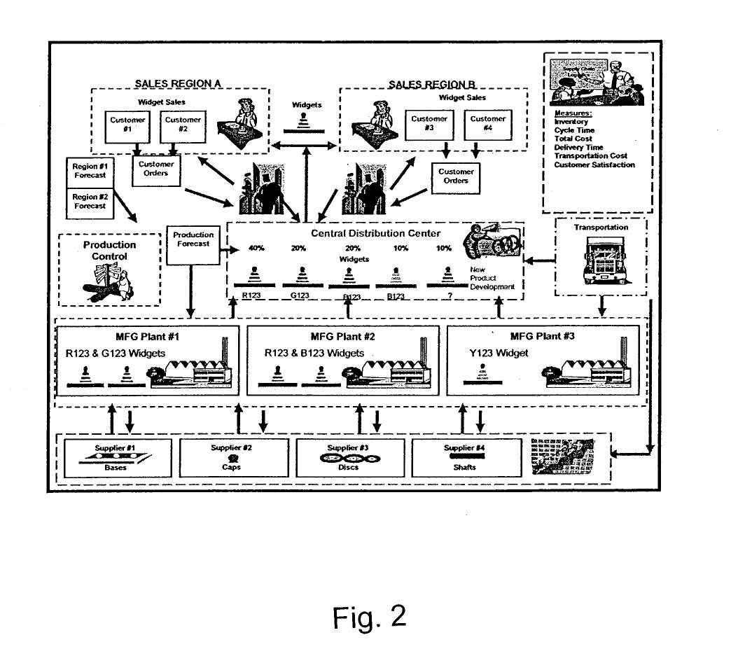

The base case model simulation will reflect current, traditional supply chain activities based upon a “Push Model.” In this scenario, the actions of plan, buy, manufacture, distribute and sell form a linear process that in most cases does not fully meet customer requirements and demands. Common practices include customer and product forecasting, aggregate production planning by product families and larger production lots, and centralized and regionalized product disbursement in the form of finished goods inventories at geographical physical locations adjacent to customer markets. The SCL Model will replicate this “Push” scenario by having an initial supply chain environment set up as shown in FIG. 2.

The base case simulation will occur in a supply chain environment in the geographic region of Widget Land. Within this region lie four unique customers located in two different sales regions. These customers buy widgets from a widget manufacturing organization that sells four distinct types of widgets. The widgets are produced in three separate manufacturing plants and distributed via a centralized distribution center located in one of the region zones. Widget manufacturing plants are somewhat specialized in the types of widgets produced at each plant and are located in three distinct physical locations. Each of these production plants are serviced by four common first tier suppliers that are located in two different physical location zones. Two transportation companies provide transportation services: The Red Truck Line (RTL) and The Blue Truck Line (BTL).

Supply Chain Model Operations Concept

Model operations start with each of the four customers placing orders for widgets for five sequential business cycles. Widget orders are forwarded to two widget company sales functions for processing and shipment. A corporate production plan is developed for all three manufacturing facilities to support the customer sales forecast and actual customer orders. Finished good widgets are strategically placed in distribution locations and plant finished goods locations to support customer order sales. The corporate production plan is broken down into detailed final assembly schedules for all plants by products, production cycles, and production lots. Raw material inventory is stored at each production facility, and suppliers are contracted and sourced for providing supply requirements to all manufacturing plants. The model simulation will start with the placement of the initial customer orders and end when all business order cycles have been completed and shipped to the customer(s). During this time, key supply chain measurement indicators will be identified and tabulated to determine the performance of the supply chain model activity.

Measurements will be calculated for the following:

Customer Delivery Time

On-Time Deliveries by Customer Orders

Revenue and Income (or Loss)

Costs: Finished Goods, Work In Process, Raw Material Inventory

Transportation Costs

Maintenance Efficiencies

Leased Space

The Product

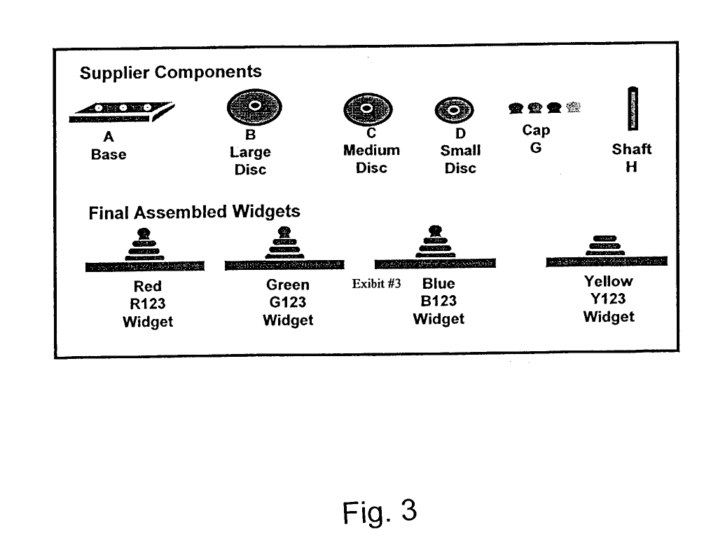

The SCL Model produces and distributes widgets, as indicated above. There are four types of widgets manufactured, distributed, and sold to customers. Each widget is made from common components supplied by four different suppliers located in two different geographic locations. Widget configuration and structure is shown in FIG. 3.

Optimized Supply Chain Simulation

Upon completion of the base case or “Push” model simulation, workshop participants will analyze the results for this simulation and then transition into a “Pull” model simulation. From the “Pull” simulation, participants will begin to discuss various supply chain concepts and enhancements that can be incorporated into the “Optimized” supply chain simulation. Model design-of-experiment variables are discussed and incorporated into the “Optimized” model simulation experiment. The model is rearranged, planned, executed and analyzed against the previous case model.

New features in the “Optimized” model include:

Pull Supply Chain Strategy and Logic

Physical Relocation of Plants, Warehouses, and Suppliers

Direct Shipments to Customers from Manufacturing Plants

Cross Dock Product Movement and Distribution

Lean Production Oriented Manufacturing Plants

Just-In-Time Delivery

Outsourcing and Part Module Kitting

EDI and B2B Electronic Commerce

Dedicated Transportation/Fleet Services

Optimized Supply Chain Model Alternative

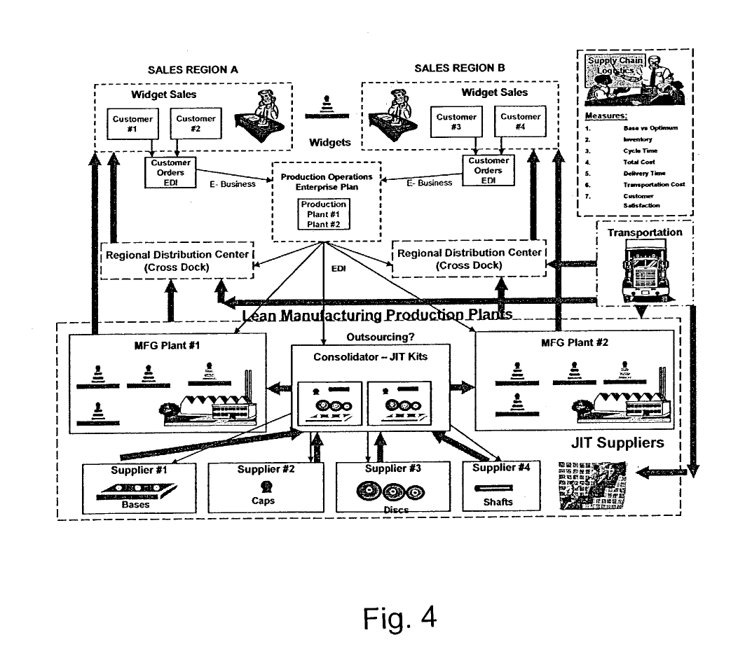

FIG. 4 displays one of many possible optimized supply chain integration scenarios that can be tested and executed with this model. In all cases, numerous design-of-experiment variables can be incorporated into different model simulations executed by model team participants.

Supply Chain Logistics Model Map

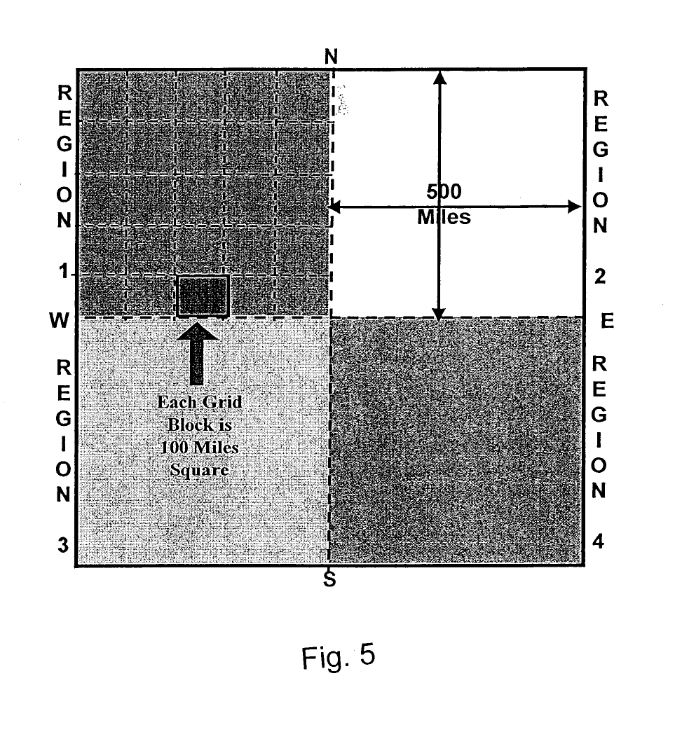

As mentioned earlier, the SCL Model simulates a geographic area called Widget Land. Widget Land is 1,000 miles square with four different regions each 500 miles square, as shown in FIG. 5.

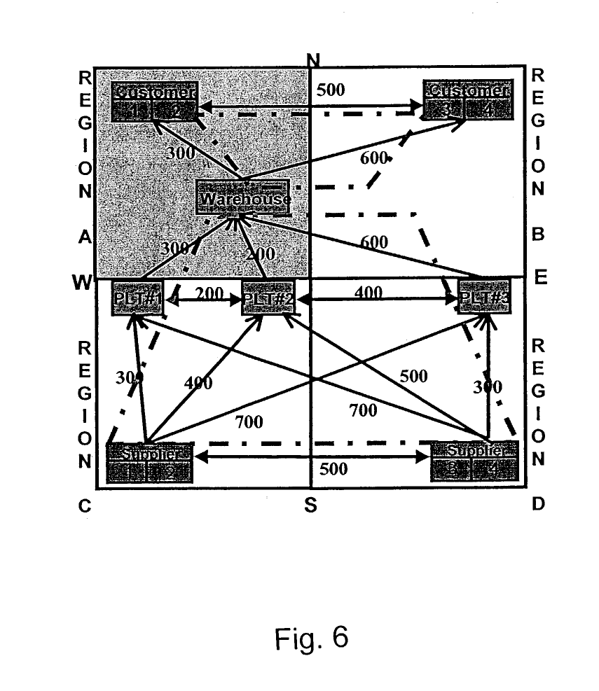

Customers, distribution warehouses, manufacturing plants, consolidators, and suppliers are located in various regions, as shown in FIG. 6. Finished goods, components, and raw material are moved throughout Widget Land by two transportation truck lines, The Red Truck Line and The Blue Truck Line.

Manufacturing Production Process

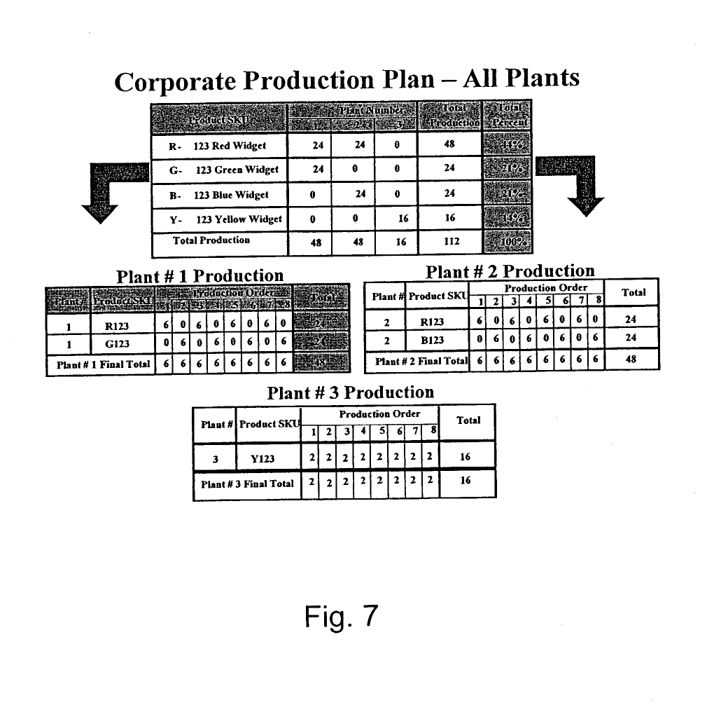

A high level production plan support forecasts requirements for the four types of widgets that are manufactured and sold to customers. The plan is synchronized to the sales forecast and broken down to specific production schedules for each of the three manufacturing plants. Widget schedules are based on larger lot sizes based upon widget type, plant location and forecast requirements. FIG. 7 shows each plant and production schedule that is executed in the base case simulation.

Model Game Boards

Model game boards are used to simulate numerous supply chain locations, functions and activities. Game boards incorporate the use of timers, simulated information terminals, components and individual activities performed by model participants.

Game boards include:

Customers

Distribution Warehouses

Manufacturing Plants

Consolidators

Suppliers

Transportation

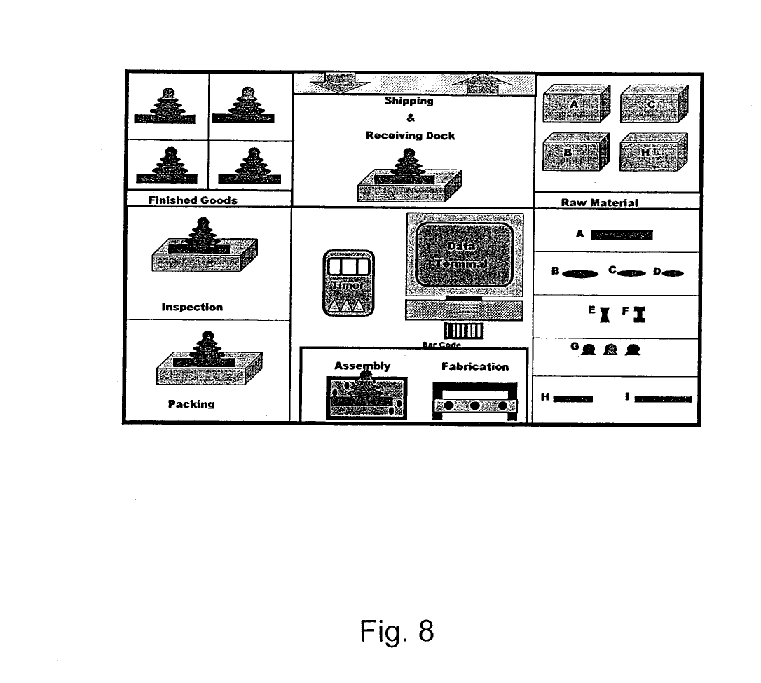

A sample game board is shown in FIG. 8.

Information Systems Simulation

The SCL Model incorporates numerous forms of information and transaction processing simulation. Supply chain information starts with customer orders for five business cycles that begin the supply chain ordering process. Orders are then processed at a simulated sales region office and shipment information is created to assist the shipping process.

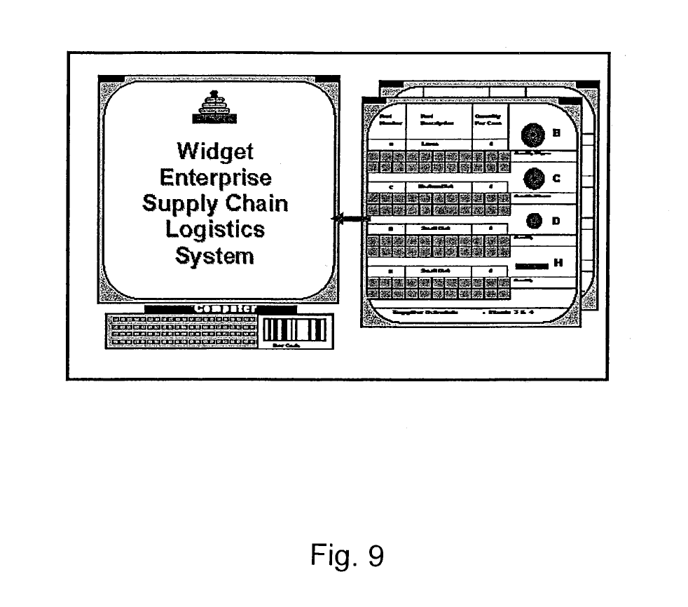

Plant information is simulated for plant schedules, supplier replenishment, and transportation dispatching. Model simulation includes the use of numerous forms and cards, discussed below, which provide information functionality and realism to model simulation and execution. FIG. 9 displays a sample simulated information transaction screen that is used in one model simulation.

Supply Chain Performance Measures

In order to effectively support the concepts of continual improvement, a series of key performance indicators are recorded for each SCL Model simulation. Measurement statistics are recorded for each model experiment and compared for each different simulation that is executed and evaluated. Key performance indicator statistics include:

Customer Delivery Time

On Time and Late Order Deliveries

Total Supply Chain Inventory and Cost

Transportation Mileage, Cost and Travel Trip Frequency

Manufacturing Inventory, Finished and Work In Process

Supply Chain Cost and Efficiency

SCL Model Participants

As indicated, the SCL Model includes a work team of at least 15 participants who will carry out the following roles: Customer, Regional Sales Manager, Distribution Warehouse Manager, Plant Manager, Supplier, Consolidator, and Truck Driver. Preferably, the work team includes at least 2 Customers, 2 Regional Sales Managers, I Warehouse Manager, 3 Plant Managers, 2 Suppliers, and 5 Truck Drivers. The Consolidator and two additional Truck Drivers are preferably added in the “Optimized” simulation.

Customer

The Customer is the starting position for the simulations. This individual is responsible for creating customer orders, updating a Customer Delivery Satisfaction Chart and role-playing with the Regional Sales Managers.

Prior to the start of the simulation, the Customer(s) will sit at his or her workstation and begin to generate customer orders. This is done by spinning a Customer Order Entry Gauge for five cycles, and recording the proper widget order on one of five Customer Order Cards. The cards are pre-numbered and have a place to enter a colored round label that is representative of the color for the widget that is being ordered. The Customer then places a numeric value for the number of widgets ordered for that particular order. Red, blue and green widgets can be ordered in quantities from one to four, and yellow widgets can be ordered in quantities of one or two. After all order cards are complete, the Customer then updates a Customer Order Log with the same labels and quantities, and then transfers this information to the Customer Delivery Satisfaction Chart located near each Customer.

The Customer will operate a timer. The timer is used to record order cycle delivery times for each order. Orders are considered “on time” if delivered in three minutes or less. After the order is delivered by the Truck Drivers, the Customer updates all logs and charts and issues new orders to the Sales Manager. The Customer can issue a new order after each three-minute order period has expired.

Partial customer order deliveries are not acceptable and should be discouraged by the Customer. Also, the Customer should inspect each widget delivery for the proper assembly sequence when they are finally delivered. Upon delivery of each widget order, the Customer will disassemble the widgets and place them in a plastic container for re-use back at the Supplier workstations.

The Customer has a bell that represents a telephone in the simulation. This bell should be rung whenever the Customer has a late order or needs information from the Sales Manager.

At the end of each simulation, the Customer will update a Data Collection Sheet used to record information to be analyzed in the SCL Financial Model, discussed below. This procedure will occur after each simulation exercise.

Regional Sales Manager

The Regional Sales Manager is responsible for interfacing with the Customer and the distribution Warehouse Manager. This individual manages one of two sales regions, and is responsible for taking customer sales orders and scheduling customer shipments. This individual will visit the Customer for each order cycle to receive customer orders, and make sure that each order has been entered on a Customer Order Transaction Screen at the sales office computer terminal. The Sales Manager works with the Distribution Warehouse Manager to share order information, assist with order filling activities and with truck dispatching.

Distribution Warehouse Manager

The Distribution Warehouse Manager manages a distribution warehouse. This individual is responsible for insuring that there are sufficient finished good widgets in the warehouse at all times. Finished goods widgets arrive based upon plant production schedules at the three Widget Plants. Widgets arrive after plants produce and ship them via the Red Truck Line. However, if there is a shortage of widgets in the warehouse, the Warehouse Manager can issue a Warehouse Replenishment Order for expediting additional widgets to the warehouse.

The Warehouse Manager exchanges information with the Regional Sales Managers and interfaces with them to fill, pack, and ship customer orders. The Warehouse Manager is responsible for requesting the Blue Truck Line drivers for delivery of customer order shipments. This individual is also responsible for truck optimization for full and partial loads on the trucks leaving the warehouse.

At the end of each simulation, the Warehouse Manager will take a complete physical inventory of finished widgets and record this information on a Distribution Inventory Status Form Data Collection Sheet.

In the “Pull” and “Optimized” simulations, the Warehouse Manager will be instructed on the use of Finished Goods Reorder Cards. These cards will be used as finished goods Kanban signals back to the plants for replenishing finished goods widgets as needed to meet shipping requirements.

Plant Manager

The Plant Manager(s) is responsible for managing the widget manufacturing plant. This individual will assemble widgets, order raw material from suppliers, request transportation services from the Red Truck Line, and work in coordination with the Distribution Warehouse Manager.

The Plant Manager will work to an established Plant Production Schedule and will follow this schedule for all production purposes. If the plant receives an emergency Warehouse Replenishment Order from the Distribution Warehouse, this order will be given production priority after the current production order currently being worked on is complete. When raw material starts to deplete, the Plant Manager will re-order needed material by issuing a Supplier Purchase Order to the appropriate supplier who manufactures these items.

At the end of each simulation, the Plant Manager will take a complete inventory material and finished goods items using a Plant Physical Inventory Form Data Collection Sheet.

For the “Pull” and “Optimized” simulations, the Plant Manager will be introduced to new methods for producing widgets. The production lot size will be reduced to two widgets per lot, and all incoming material from the Supplier will now be brought in Just-In-Time through the use of Kanban Cards or Part Kit Cards. The “Push” Production Schedule will be replaced with a new “Pull” signaling system that uses Kanban Finished Goods Reorder Cards from the distribution Warehouse. Small “supermarket” areas will be established in the finished goods output area of each plant using color-coded labels in specially marked shipping containers with the reorder cards in each container.

Supplier

The Supplier is responsible for producing and shipping all component parts that are used by the downstream widget plants. This material is considered “raw material” upon entry to the supplier's plant and, when boxed up in plastic shipping containers, the material is considered finished goods components and enters the logic of the SCL Financial Model's evaluation and analysis system for this model.

The Suppliers are identified as four distinct Suppliers, and are physically located in two different regions within Widget Land. Suppliers work to well-defined production schedules to support Widget, Inc.'s forecast for purchased components. Suppliers' primary functions include manufacturing and storing finished goods components, filling Supplier Purchase Order requests from widget plants and working with the Red Line Truck organization to deliver products to the plants.

At the end of each simulation, the Supplier will take a complete inventory of parts and update a Supplier Inventory Form Data Collection Sheet.

Consolidator

The Consolidator is responsible for coordinating the collection of numerous parts from different upstream components suppliers and creating unique part kits for delivery to downstream widget plants. This function is also commonly referred to as a “Third Party Logistics” (3PL) function.

This function will be introduced in the “Optimized” simulation. When introduced, the Consolidator's function will work in the supply chain between the existing components part suppliers and the widget manufacturing plants. A dedicated truck line, called the Brown Truck Line, will be added to support the Consolidator's function. These trucks will be dedicated to picking up component parts at the Supplier locations and delivering them back to the consolidator's location.

The Consolidator's function is to build part kits. A part kit is a unique accumulation of parts required to go to the widget plant and be assembled into a finished good widget. Part kits will consist of two sets of parts that include: A-base, B, C, D-discs, and H-the shaft.

All part kits will be put into specially labeled shipping containers that contain Part Kit Cards to identify each container. These cards are also labeled for two unique plants—Plant#1 and Plant #2—whereby both plants have different staging areas at the Consolidator workstation.

At the end of each simulation, the Consolidator will take a complete inventory of parts at its location and record this information on a Consolidator Inventory Form Data Collection Sheet.

Truck Driver

The Truck Driver is responsible for transporting all raw materials, part kits, and finished goods around Widget Land. Driving time is simulated in this model. Ten seconds represents a driving distance equal to 100 miles. This concept allows for very real simulated driving times from one location to the next.

Each Truck Driver has one tractor-trailer. The trucks have a maximum capacity of four containers that can either store four full boxes of raw material, or four shipping containers that can contain a maximum of eight finished goods widgets, stored two per shipping container.

Truck Drivers will be responsible for operating their trucks, checking for maintenance failures by using a Maintenance Gauge, updating a Truck Trip Travel Log Chart and working with plant, warehouse, sales and customer personnel.

Truck Maintenance will be simulated using the Maintenance Gauge. Initially, the maintenance uptime will start at 85%, and will be improved to 95% for the “Optimized” simulation. Maintenance down time is 30 seconds, which represents half of a normal transportation travel day that is 600 miles.

Primary truck driving responsibilities include:

Loading the truck with component and shipping containers.

Setting a Trip Indicator for the proper destination, and setting the timer for the proper travel time.

Start the timer and begin the trip, making sure to transfer the trip destination travel distance label to the right mileage column on a Route Travel Trip Chart. Colored labels are counted and posted to a Truck Trip Travel Log after each simulation. Colored labels are then removed from the Route Travel Trip Chart so that the chart can be used for the next simulation.

Spinning the Maintenance Gauge and recording a maintenance breakdown, if the gauge stops in the “Red” breakdown area of the gauge. Truck Drivers also update the maintenance breakdown template with a color-coded breakdown label.

SCL Financial Model

The purpose of the SCL Financial Model is to provide a means for collecting and analyzing the results from each of the workshop simulations discussed above across the entire supply chain in a manner that is consistent with current business analysis. The model will allow the workshop participants to analyze the impact to customer delivery performance, the enterprise's financial position, and the costs across the entire supply chain resulting from changes in both the operating and physical aspects of the supply chain.

Data Entry Sheet and Calculation Sheets

The Financial Model uses a Data Entry Sheet for entering data that is collected at the beginning and the end of each simulation, as previously described. There are also three Calculation Sheets labeled “Push”, “Pull”, and “Opt”. These sheets take the data from the Data Entry Sheet, calculate this data into useful information that is then imported to other sheets for analysis.

Simulation Time

The total time of the 5-cycle simulation in minutes and the closest quarter of a minute is entered in the Data Entry Sheet. For example, if the actual time on the stopwatch for the simulation is 16:24.9, which represents 16 minutes and 24.9 seconds, then the time of 16.50 for 16 and one half minutes would be entered.

| TOTAL SIMULATION TIME (Minutes) | PUSH | PULL | OPT |
|---|---|---|---|
| | 16.50 | | |

Customer Delivery Status

Net sales are calculated from the entries made to the next data block titled Customer Delivery Status Form. The total quantity of widgets ordered and those that were delivered and late are entered for each customer. In the below example, there were a total of 12 widgets delivered to Customer #1 with 11 of these widgets being delivered on time and 1 delivered late.

(On “Data” sheet)
CUSTOMER DELIVERY STATUS FORM

| DELIVERY STATUS | | | | | | | |
|---|---|---|---|---|---|---|---|
| | TTL | PUSH | | PULL | | OPTIMIZED | |
| | WIDGETS | On- | | On- | | On- | |
| CUSTOMER | ORDERED | time | Late | time | Late | time | Late |
| 1 | 12 | 11 | 1 | | | | |
| 2 | 14 | 6 | 8 | | | | |
| 3 | 9 | 5 | 4 | | | | |
| 4 | 12 | 6 | 6 | | | | |
| WIDGETS | 47 | 28 | 19 | 0 | 0 | 0 | 0 |

To calculate revenue, the program automatically multiplies the total number of widgets delivered by the price of one widget, $60,000. A 10% penalty is charged for each widget that is delivered late. The late fee is used to emphasize the importance of delivering product on time. These calculations are made on the “Push” Calculation Sheet in the below example. Net sales on the Accountant's Sheet and on the Income Statement, discussed below, will indicate 706,000 or $2,820,000 of gross revenue minus the $114,000 penalty for the 19 total widgets that were delivered late.

(On “Push” calculation sheet)
Revenue

| | | Quan- | | |
|---|---|---|---|---|
| | | tity | Price | Revenue |
| Customer #1 | Total Widgets Delivered | 12 | $60,000 | $720,000 |
| | Widgets Delivered Late | 1 | $6,000 | $6,000 |
| Customer #2 | Total Widgets Delivered | 14 | $60,000 | $840,000 |
| | Widgets Delivered Late | 8 | $6,000 | $48,000 |
| Customer #3 | Total Widgets Delivered | 9 | $60,000 | $540,000 |
| | Widgets Delivered Late | 4 | $6,000 | $24,000 |
| Customer #4 | Total Widgets Delivered | 12 | $60,000 | $720,000 |
| | Widgets Delivered Late | 6 | $6,000 | $36,000 |

| | | |
|---|---|---|
| Total Widgets Delivered | 47 | $2,820,000 |
| Widgets Delivered Late | 19 | $114,000 |

Inventory Costs

Inventory is separated into that owned by the “company” and that owned by the “suppliers”. This allows accounting not only for the company's inventory on the Financial Statements (explained later), but also tracking of the supplier's inventory since the cost within the entire supply chain is important.

As stated above and seen in the below example of the “Push” case, beginning inventory for both the company and the suppliers has already been entered into the Data Entry Sheet since this inventory was preset prior to running the simulation. However, since the workshop participants make decisions about the quantity of beginning inventory in both the “Pull” and the “Optimized” simulations, those quantities must be recorded on the data Collection Sheets and entered into the appropriate fields of the Data Entry Sheet.

When entering ending finished goods and raw material inventory for the company, quantities at the distribution center (DC) and all three manufacturing plants must be entered into the appropriate fields of the Data Entry Sheet, as shown below. The example below shows that there were a total of 41 finished widgets in inventory at the DC and the three plants at the end of the “Push” simulation.

(On “Data” sheet)

| INVENTORY | | | | | | | |
|---|---|---|---|---|---|---|---|
| STATUS | | PUSH | | PULL | | OPTIMIZED | |
| PAR- | DESCRIP- | ON HAND | | ON HAND | | ON HAND | |
| T # | TION | START | END | START | END | START | END |

DISTRIBUTION INVENTORY STATUS FORM

| | | | |
|---|---|---|---|
| R123 | RED | 10 | 8 |
| G123 | GREEN | 4 | 8 |
| B123 | BLUE | 4 | 8 |
| Y123 | YELLOW | 2 | 8 |

| | | | | | | |
|---|---|---|---|---|---|---|
| TOTAL ON HAND | 20 | 32 | 0 | 0 | 0 | 0 |

PLANT PHYSICAL INVENTORY FORM PLANT: 1

| | | | |
|---|---|---|---|
| A | BASE | 4 | 12 |
| B | LARGE DISC | 10 | 20 |
| C | MEDIUM DISC | 10 | 15 |
| D | SMALL DISC | 10 | 15 |
| H | SHAFT | 20 | 20 |
| 123 | WIDGET | 2 | 3 |

PLANT PHYSICAL INVENTORY FORM PLANT: 2

| | | | |
|---|---|---|---|
| A | BASE | 4 | 12 |
| B | LARGE DISC | 10 | 20 |
| C | MEDIUM DISC | 10 | 10 |
| D | SMALL DISC | 10 | 10 |
| H | SHAFT | 20 | 20 |
| 123 | WIDGET | 2 | 3 |

PLANT PHYSICAL INVENTORY FORM PLANT: 3

| | | | |
|---|---|---|---|
| A | BASE | 4 | 12 |
| B | LARGE DISC | 10 | 12 |
| C | MEDIUM DISC | 10 | 10 |
| D | SMALL DISC | 10 | 10 |
| H | SHAFT | 20 | 18 |
| 123 | WIDGET | 2 | 3 |

The company inventory fields on the “Push” Calculation Sheet indicates that finished good inventory grew from $1,040,000 to $1,640,000 and raw material inventory grew from $600,000 to $1,103,000 resulting in a growth of total inventory from $1,640,000 to $2,743,000.

(On “Push” calculation sheet)
Inventory Costs (Company)

| | | | Beginning | | Ending | |
|---|---|---|---|---|---|---|
| Product/Component | | Value | Quantity | Cost | Quantity | Cost |
| Finished Goods | Widget | $40,000 | 26 | $1,040,000 | 41 | $1,640,000 |
| Raw Material | Base | $15,000 | 12 | $180,000 | 36 | $540,000 |
| | Lg Disk | $5,000 | 30 | $150,000 | 52 | $260,000 |
| | Med Disk | $4,000 | 30 | $120,000 | 35 | $140,000 |
| | Sm Disk | $3,000 | 30 | $90,000 | 35 | $105,000 |
| | Shaft | $1,000 | 60 | $60,000 | 58 | $58,000 |

| | | |
|---|---|---|
| Raw Material Cost | $600,000 | $1,103,000 |
| Total Inventory Cost (Company) | $1,640,000 | $2,743,000 |

In the “Optimized” simulation, a consolidator is added to the supplier network. This service is not given without added cost to the company. Therefore, the company's raw material costs are increased by 3% as shown in the example below.

(On “Opt” calculation sheet)
Inventory Costs (Company)

| | | | Beginning | | Ending | |
|---|---|---|---|---|---|---|
| Product/Component | | Value | Quantity | Cost | Quantity | Cost |
| Finished Goods | Widget | $40,840 | 26 | $1,061,840 | 16 | $653,440 |
| Raw Material | Base | $15,450 | 8 | $123,600 | 4 | $61,800 |
| | Lg Disk | $5,150 | 8 | $41,200 | 4 | $20,600 |
| | Med Disk | $4,120 | 8 | $32,960 | 3 | $12,360 |
| | Sm Disk | $3,090 | 8 | $24,720 | 4 | $12,360 |
| | Shaft | $1,030 | 8 | $8,240 | 4 | $4,120 |

| | | |
|---|---|---|
| Raw Material Cost | $230,720 | $111,240 |
| Total Inventory Cost (Company) | $1,292,560 | $764,680 |

Note that the value of Finished Goods also increases in this case due to the increase in raw material costs, but not by a total of 3% since this value also includes labor and factory overhead that does not increase in costs.

Leased Warehouse Space

If additional warehousing space was required during the course of a simulation, a “1” entered in the appropriate cell on the Data Entry Sheet as shown below for the “Push” simulation. A corresponding expense will automatically be added on the Income Statement, discussed below. If the leased warehouse space is not used during a simulation, then nothing is entered in this cell.

(On “Data” sheet)

| | | | |
|---|---|---|---|
| LEASED WAREHOUSE SPACE | PUSH | PULL | OPT |

1

Supplier Inventory

Inventory that is collected from the suppliers is to be entered into appropriate cells within the suppliers' inventory data fields on the Data Entry Sheet as shown in the example below:

(On “Data” sheet)

| FINISHED GOODS | | | | | | |
|---|---|---|---|---|---|---|
| INVENTORY | PUSH | | PULL | | OPTIMIZED | |
| STATUS | START | END | START | END | START | END |

SUPPLIER INVENTORY FORM SUPPLIERS: 1 & 2

| | | | |
|---|---|---|---|
| A | BASE | 24 | 12 |

Total Inventory

SUPPLIER INVENTORY FORM SUPPLIERS: 3 & 4

| | | | |
|---|---|---|---|
| B | LARGE DISC | 30 | 10 |
| C | MEDIUM DISC | 30 | 30 |
| D | SMALL DISC | 30 | 30 |
| H | SHAFT | 80 | 80 |

Total Inventory

The suppliers' inventory will be automatically transferred to the Calculation Sheet were total cost will be calculated as shown in the example below:

(On “Push” calculation sheet)
Inventory Costs (Supplier)

| | | | Beginning | | Ending | |
|---|---|---|---|---|---|---|
| Product/ | | | Quan- | | Quan- | |
| Component | | Value | tity | Cost | tity | Cost |
| Raw | Base | $10,000 | 24 | $240,000 | 12 | $120,000 |
| Material | | | | | | |
| | Lg Disk | $3,300 | 30 | $99,000 | 10 | $33,000 |
| | Med Disk | $2,600 | 30 | $78,000 | 30 | $78,000 |
| | Sm Disk | $2,000 | 30 | $60,000 | 30 | $60,000 |
| | Shaft | $700 | 80 | $56,000 | 80 | $56,000 |

| | | |
|---|---|---|
| Raw Material Cost | $533,000 | $347,000 |
| Total Inventory Cost (Supplier) | $533,000 | $347,000 |

Transportation

Additional data blocks in the Data Entry Sheet deal with transportation within the supply chain. The block shown below is for recording the number of maintenance delays that occurred in the simulation. The below example shows that there was a total of 12 maintenance delays at the Red and Blue Truck Line companies.

(On “Data” sheet)

| MAINTENANCE DELAYS | PUSH | PULL | OPT |
|---|---|---|---|
| | 12 | | |

Similar to the inventory costs above, the transportation costs born by the company is separated from the rest of the supply chain. This is done in order to account for the company's cost in its Financial Statements, but still analyze transportation costs across the entire supply chain. In the simulations, the suppliers turn over products to the company Free-On-Board (FOB) their docks. This means that the company bears the costs of transporting raw materials from the suppliers to the manufacturing plants. And, since the DC is also part of the company, the company bears the cost of transporting finished widgets from the plants to the DC.

Similarly, the company turns over finished widgets to the customers FOB the DC dock. Therefore, the customers bear the cost of transporting finished widgets from the DC to their locations.

To facilitate this transportation and to keep the recording accurate, the Red Truck Line company will conduct the transportation activities charged to the company and the Blue Truck Line company will conduct the transportation activities charged to the customers. Also note that the suppliers will take on some transportation costs when the consolidator is added in the third, “Optimized” simulation, which will be conducted by the Brown Truck Line company.

Once the data has been collected after the simulation, it is entered into the appropriate cells of the data blocks on the Data Entry Sheet, as shown below:

(On “Data” sheet)
TRUCK LINE ROUTE TRIP FORM

| TRANSPORTATION LINE ROUTE TRUCK TRIPS | | | | | | | | |
|---|---|---|---|---|---|---|---|---|
| (number of trips by mile category) | | | | | | | | |
| 100 | 200 | 300 | 400 | 500 | 600 | 700 | 800 | 900 |

Red Line

| | | | | | | |
|---|---|---|---|---|---|---|
| Push | 3 | 10 | 1 | 4 | 3 | 4 |
| Pull | | | | | | |
| Opt. | | | | | | |

Blue Line

| | | |
|---|---|---|
| Push | 6 | 8 |
| Pull | | |
| Opt. | | |

Brown Line

Push
Pull
Opt.

This information automatically flows to the Calculation Sheets were transportation costs are then calculated. Note that the data blocks in the following example have columns for both Panel trucks (Day Vans) and Semi trucks with different costs associated for each. A Panel truck holds two skids of widgets while a Semi holds four. The trucks in the simulation can be modified so that participants can select which type of truck to operate for a particular route or transportation run.

(On “Push” calculation sheet)

| Transportation Costs (Company) | | | | | | (Red Line) | |
|---|---|---|---|---|---|---|---|
| Trip | Trips | | Miles | | Cost/Trip | | |
| Mileage | Panel | Semi | Panel | Semi | Panel | Semi | Cost |
| 100 | | 0 | 0 | 0 | $130 | $200 | $0 |
| 200 | | 3 | 0 | 600 | $270 | $400 | $1,200 |
| 300 | | 10 | 0 | 3000 | $400 | $600 | $6,000 |
| 400 | | 1 | 0 | 400 | $530 | $800 | $800 |
| 500 | | 4 | 0 | 2000 | $670 | $1,000 | $4,000 |
| 600 | | 3 | 0 | 1800 | $770 | $1,150 | $3,450 |
| 700 | | 4 | 0 | 2800 | $870 | $1,300 | $5,200 |
| 800 | | 0 | 0 | 0 | $970 | $1,450 | $0 |
| 900 | | 0 | 0 | 0 | $1,070 | $1,600 | $0 |
| 1000 | | | 0 | 0 | $1,170 | $1,750 | $0 |
| Totals | 0 | 25 | 0 | 10600 | | | $20,650 |
| Transportation Costs (Customers) | | | | | | (Blue Line) | |
| Trip | Trips | | Miles | | Cost/Trip | | |
| Mileage | Panel | Semi | Panel | Semi | Panel | Semi | Cost |
| 100 | | 0 | 0 | 0 | $130 | $200 | $0 |
| 200 | | 0 | 0 | 0 | $270 | $400 | $0 |
| 300 | | 6 | 0 | 1800 | $400 | $600 | $3,600 |
| 400 | | 0 | 0 | 0 | $530 | $800 | $0 |
| 500 | | 0 | 0 | 0 | $670 | $1,000 | $0 |
| 600 | | 8 | 0 | 4800 | $770 | $1,150 | $9,200 |
| 700 | | 0 | 0 | 0 | $870 | $1,300 | $0 |
| 800 | | 0 | 0 | 0 | $970 | $1,450 | $0 |
| 900 | | 0 | 0 | 0 | $1,070 | $1,600 | $0 |
| 1000 | | | 0 | 0 | $1,170 | $1,750 | $0 |
| Totals | 0 | 14 | 0 | 6600 | | | $12,800 |

All of the data that has been added to the Data Entry Sheet “flows” through the remainder of this financial model and is used to obtain the results on the Analysis Sheets.

Financial Statements

There two Financial Statements used in the SLC Financial Model for the company that includes the manufacturing plants and the distribution center; a Balance Sheet and an Income Statement. These Financial Statements are accessed in the workshop financial model by selecting a tab labeled “Financial Statements”.

Balance Sheet

Since a balance sheet shows the financial status of a business entity at a particular instance in time, a starting point is determined that represents the company's Balance Sheet just prior to the base case simulation. As seen below, ASSETS include $40 million in current assets and $100 million in fixed, long-term assets (plants, property and equipment) for a total of $140 million.

There are a total of $80 million in LIABILITIES that consist of $20 million in current liabilities, $10 million in short-term debt, and $50 million in long-term debt. Debt has been included in this model to show both the impact that debt has on net income due to interest expense and to show the benefit that can be gained through the use of debt as financial leverage.

The $140 million in assets and the $80 million in liabilities result in EQUITY of $60 million at this starting point as see in the example below:

Balance Sheet (Initial)

Start

| | | |
|---|---|---|
| Current Assets | | 40,000,000 |
| Plants & Property | QTY | |
| $15,000,000 per Plant | 3 | 45,000,000 |
| $10,000,000 Dist. Center | 1 | 10,000,000 |
| Equipment | | 45,000,000 |
| Total Assets | | $140,000,000 |
| Current Liabilities | | 20,000,000 |
| Curr. Lia. (Sh. Term Debt) | | 10,000,000 |
| Long Term Debt | | 50,000,000 |
| Total Liabilities | | $80,000,000 |
| Equity | | $60,000,000 |

After the “Push” simulation is conducted, all of the data is to be entered into the Data Entry Sheet as explained previously. The Balance Sheet will now look as it looks in the following example when the Financial Statements sheet is opened.

Note that current assets have increased by $1,440,106. This is due to the $1,103,000 increase in company inventory costs from the beginning of the simulation to the end of the simulation plus $337,106 from positive cash flow during the period. Short-term liabilities also increase by $1,103,000 to pay for the inventory increase. And, the resulting equity level reflects the retained earnings from the positive cash flow. The SCL Financial Model automatically adjusts current assets with the changes in inventory levels after each simulation.

Note also that there are no fixed asset values for “Plant” or “Dist. Center” in the Balance Sheet. To obtain the correct fixed asset values, the quantities of each need to be entered into the appropriate cells under “QTY” as shown on the Balance Sheet example. Creating the balance sheet in this manner allows the workshop facilitators to experiment with the quantity of physical manufacturing plants and the size of the DC in the simulation to see both how this will impact the service to the customers and what financial impact it will have on the company.

Once the quantities of 3 and 1 are added for the number of plants and the size of the DC, respectively, the values for Total Assets and Equity will adjust automatically to the correct levels as seen below.

Balance Sheet (After Push Simulation)

| | Start | | Push State | |
|---|---|---|---|---|
| Current Assets | | 40,000,000 | | 41,440,106 |
| Plants & Property | QTY | | QTY | |
| $15,000,000 per | 3 | 45,000,000 | 3 | 45,000,000 |
| Plant | | | | |
| $10,000,000 Dist. | 1 | 10,000,000 | 1 | 10,000,000 |
| Center | | | | |
| Equipment | | 45,000,000 | | 45,000,000 |
| Total Assets | | $140,000,000 | | $141,440,106 |
| Current Liabilities | | 20,000,000 | | 20,000,000 |
| Curr. Lia. (Sh. Term | | 10,000,000 | | 11,103,000 |
| Debt) | | | | |
| Long Term Debt | | 50,000,000 | | 50,000,000 |
| Total Liabilities | | $80,000,000 | | $81,103,000 |
| Equity | | $60,000,000 | | $60,337,106 |

An example of the financial impact from a change in fixed assets can be seen in the Balance Sheet below. During the “Optimized” simulation, the number of plants is reduced to 2 and the DC is reduced by 50%. If those unutilized assets were sold for $15 million and $5 million, respectively, the result is an excess of $20 million in cash. Since in the workshop simulation there is not a good investment opportunity for this excess cash that will generate more income, and since it is not a good business solution to let it set idly in current assets, it is decided to buy down $20 million of debt for a reduction to $30 million. This action has an impact on the level of total assets and liabilities, and on the net income due to the resulting reduction in the interest payment when the Income Statement is analyzed.

Balance Sheet (End of Business Cycle)

| | Start | | Push State | | Pull State | | Optimized State | |
|---|---|---|---|---|---|---|---|---|
| Current Assets | | 40,000,000 | | 41,440,106 | | 40,003,350 | | 39,547,471 |
| Plants & Property | QTY | | QTY | | QTY | | QTY | |
| $15,000,000 per Plant | 3 | 45,000,000 | 3 | 45,000,000 | 3 | 45,000,000 | 2 | 30,000,000 |
| $10,000,000 Dist. Center | 1 | 10,000,000 | 1 | 10,000,000 | 1 | 10,000,000 | 0.5 | 5,000,000 |
| Equipment | | 45,000,000 | | 45,000,000 | | 45,000,000 | | 45,000,000 |
| Total Assets | | $140,000,000 | | $141,440,106 | | $140,003,350 | | $119,547,471 |
| Current Liabilities | | 20,000,000 | | 20,000,000 | | 20,000,000 | | 20,000,000 |
| Curr. Lia. (Sh. Term Debt) | | 10,000,000 | | 11,103,000 | | 9,636,000 | | 9,124,680 |
| Long Term Debt | | 50,000,000 | | 50,000,000 | | 50,000,000 | | 30,000,000 |
| Total Liabilities | | $80,000,000 | | $81,103,000 | | $79,636,000 | | $59,124,680 |
| Equity | | $60,000,000 | | $60,337,106 | | $60,367,350 | | $60,422,791 |

Income Statement

An income statement is a report of all revenues and expenses over a specific period of time for a business entity. Therefore, the five business cycles of each simulation are used as one reporting period for the Income Statement within this financial model. The below example is a resulting Income Statement from all three simulations. Note that the Income Statement is complete, requiring no additional information.

Income Statement (5 Business Cycles)

| | Push State | Pull State | Optimized State |
|---|---|---|---|
| Net Sales | $2,706,000 | $2,742,000 | $2,802,000 |
| Cost Of Goods Sold | 1,880,000 | 1,880,000 | 1,919,480 |
| Sales, General & | 240,000 | 240,000 | 200,000 |
| Admin | | | |
| Depreciation | 150,747 | 150,747 | 140,885 |
| Transportation | 20,650 | 18,500 | 11,600 |
| Leased Warehouse | 10,000 | 0 | 0 |
| Space | | | |
| Total Expenses | $2,301,397 | $2,289,247 | $2,271,965 |
| Operating Income | $404,603 | $452,753 | $530,035 |
| Interest Expense | 94,005 | 91,748 | 60,192 |
| Taxes @ 40% | 124,239 | 144,402 | 187,937 |
| Net Income | $186,359 | $216,603 | $281,906 |

Income Statement Explanation

The following is a detailed explanation of each line of the Income Statement so that the facilitator can address questions from the workshop participants.

Net Sales comes from the data sheet, and is the total number of widgets delivered multiplied by $60,000 (price of each widget) minus a 10% fee for each widget delivered late.

Cost of Goods Sold is the total number of widgets delivered multiplied by $40,000 (finished goods inventory value of a widget) and represents raw material, direct and indirect labor, and factory overhead costs. Note: the COGS in the “Optimized” simulation is higher than in the two previous cases due to the 3% increase in raw material costs that resulted from adding the consolidator.

Sales, General & Administration is a constant number that represents all other overhead costs. Note that SG&A is reduced to $200,000 in the “Optimized” simulation due to the operation of 2 plants versus 3 in the first two simulations.

Depreciation is calculated from MACRS annual depreciation tables for the specific fixed asset level in each simulation, and is then adjusted to determine the depreciation charge for the 5 business cycles of the simulation.

Transportation costs come from the data sheet, and are the costs incurred by the company.

Leased Warehouse Space is an expense charge if the initial space at the distribution center is completely filled with inventory and addition space is required.

Total Expenses is the sum of COGS, SG&A, Depreciation, Transportation and Leased Warehouse Space.

Operating Income is Net Sales minus Total Expenses.

Interest Expense is the short-term and long-term debt level taken from the balance multiplied by an annual rate of 8% and then adjusted to determine the interest expense that is incurred over the five business cycles of the simulation.

Tax is Operating Income minus Interest Expense multiplied by a tax rate of 40%.

Net Income is Operating Income minus Interest Income and Taxes.

Accountant's Summary Sheet

The Accountant's Summary Sheet is a tabulated one-page summary of all the information that is pertinent to the company and its operations.

Accountant

| | Push | Pull | Opt |
|---|---|---|---|
| | Total Time | | |
| | 16.50 | 13.50 | 9.75 |
| Revenue & Income | | | |
| Widgets Delivered | 47 | 47 | 47 |
| Widgets Delivery Late | 19 | 13 | 3 |
| Net Sales | $2,706,000 | $2,742,000 | $2,802,000 |
| Operating Income | $404,603 | $452,753 | $530,035 |
| Net Income | $186,359 | $216,603 | $281,906 |
| Inventory | | | |
| Finished Goods | | | |
| Beginning | $1,040,000 | $1,200,000 | $1,061,840 |
| Ending | $1,640,000 | $1,000,000 | $653,440 |
| Raw Material | | | |
| Beginning | $600,000 | $560,000 | $230,720 |
| Ending | $1,103,000 | $276,000 | $111,240 |
| Total Inventory Costs | | | |
| Beginning | $1,640,000 | $1,760,000 | $1,292,560 |
| Ending | $2,743,000 | $1,276,000 | $764,680 |
| Transportation | | | |
| Truck Trips | 25 | 25 | 25 |
| Truck Miles | 10600 | 9500 | 5800 |
| Transportation Costs | $20,650 | $18,500 | $11,600 |

Results Analysis

The remaining sheets of the SCL Financial Model are a collection of information in graphic form so that the results of the three simulations can be analyzed and compared. These graphs are automatically built as data is entered into the Data Entry Sheet and the Balance Sheet of the Financial Statements. This enables the facilitator to review and analyze the results with the workshop participants at the conclusion of each simulation.

[image]

Ratios

The Financial Ratios Sheet graph Return on Equity, Operating Income, Return pm Assets [also known as Basic Earning Power (BEP)] and Net Income Return on Assets.

| | Scenario | | |
|---|---|---|---|
| | Push | Pull | Opt |
| Revenue | $140,712,000 | $142,584,000 | $145,704,000 |
| Operating In- | $21,039,372 | $23,543,172 | $27,561,833 |
| come | | | |
| Net Income | $9,690,679 | $11,263,375 | $14,659,115 |
| Assets | $141,440,106 | $140,003,350 | $119,547,471 |
| Equity | $60,337,106 | $60,367,350 | $60,422,791 |
| OIROA | 14.9% | 16.8% | 23.1% |
| NIROA | 6.9% | 8.0% | 12.3% |
| ROE | 16.1% | 18.7% | 24.3% |

[image]

[image]

Inventory

The Inventory Results Sheet graphs Inventory Turns and Inventory Costs incurred by the company.

| | Scenario | | |
|---|---|---|---|
| | Push | Pull | Opt |
| RMI Costs | | | |
| Beginning | $600,000 | $560,000 | $230,720 |
| Ending | $1,103,000 | $276,000 | $111,240 |
| FGI Costs | | | |
| Beginning | $1,040,000 | $1,200,000 | $1,061,840 |
| Ending | $1,640,000 | $1,000,000 | $653,440 |
| Total Costs | | | |
| Beginning | $1,640,000 | $1,760,000 | $1,292,560 |
| Ending | $2,743,000 | $1,276,000 | $764,680 |

[image]

Inventory (Supplies)

The Suppliers' Inventory Results Sheet graphs the inventory costs incurred by the suppliers and totals the inventory in the entire supply chain.

| | Scenario | | |
|---|---|---|---|
| | Push | Pull | Opt |
| RMI Costs | | | |
| Beginning | $533,000 | $300,400 | $440,800 |
| Ending | $347,000 | $148,800 | $243,300 |
| Supply Chain Total Costs | | | |
| Beginning | $2,173,000 | $2,060,400 | $1,733,360 |
| Ending | $3,090,000 | $1,424,800 | $1,007,980 |

[image]

Transportation

The Tranportation Results Sheet graphs truck up-time, number of trips, miles and costs for the company, customers, suppliers and the total supply chain. Truck up time is calculated by the time all trucks are traveling and moving products divided by the sum of travel time plus down time due to maintenance delays.

| | | Scenario | | |
|---|---|---|---|---|
| | | Push | Pull | Opt |
| | Truck Up-Time | 83% | 90% | 95% |
| Costs | Company | $20,650 | $18,500 | $11,600 |
| | Customer | $12,800 | $12,800 | $9,000 |
| | Supplier | $0 | $0 | $3,600 |
| | Total | $33,450 | $31,300 | $24,200 |
| Trips | Company | 25 | 25 | 25 |
| | Customer | 14 | 14 | 15 |
| | Supplier | 0 | 0 | 9 |
| | Total | 39 | 39 | 49 |
| Miles | Company | 10600 | 9500 | 5800 |
| | Customer | 6600 | 6600 | 4500 |
| | Supplier | 0 | 0 | 1800 |
| | Total | 17200 | 16100 | 12100 |

[image]

[image]

Supply Chain Capacity and Potential

The Capacity Results Sheet graphs the capacity of the supply chain and actual revenue, operating income and net income against the resulting potential of each due to the supply chain capacity. The capacity of the supply chain is determined by dividing 15 minute (the exact time it takes to fulfill five orders on-time) by the actual time of the simulation. The resulting percentage indicates how much capacity is in the supply chain compared to what is required to deliver the 5 orders to each of the 4 customers on time. If the capacity percentage is below 100%, as shown in the “Push” example below, then the supply chain is under the capacity needed to deliver the orders on-time, every time. And if the capacity percentage is greater than 100%, as shown in the “Pull” and “Optimized” examples below, this indicates that the supply chain has excess capacity built into it that would allow for increased sales without increasing the asset base of the company.

For the graphs of revenue, operating income, and net income (shown below), “Actual” is the value previously reported for each particular simulation. The “Potential” value is the value of each financial component if the sales were adjusted to match the capacity of the supply chain for that particular simulation. Note that income increases in the “Pull” and “Optimized” simulation are much greater than the increase in revenue. This is due to the fact that expenses on increment sales are lower, since most expenses such as SG&A and Interest expense are fixed and do not vary with sales volume.

The last sheet of the SCL Financial Model, ESP, is a balance sheet and an income statement used to calculate revenue, operating income, and net income potential and is not further explained or covered in the workshop.

| | | Scenario | | |
|---|---|---|---|---|
| | | Push | Pull | Opt |
| | Capacity | 91% | 111% | 154% |
| Revenue | Actual | $2,706,000 | $2,742,000 | $2,802,000 |
| | Potential | $2,563,636 | $3,133,333 | $4,338,462 |
| OI | Actual | $404,603 | $452,753 | $530,035 |
| | Potential | $443,149 | $635,198 | $1,032,931 |
| NI | Actual | $186,359 | $216,603 | $281,906 |
| | Potential | $209,486 | $326,070 | $583,643 |

Supply Chain Capacity and Potential (cont'd)

[image]

[image]

A supply chain logistics simulation model and workshop are described above. aVarious details of th einvention may be changed without departing from its scope. Furthermore, the foregoing description of the preferred embodiment of th einvention and best mode for practicing the invention are provided for the purpose of illustration only and not for the purpose of linitation—the invention being defined by the claims.

We claim:

1. A supply chain logistics model adapted to educate and train a number of workshop participants in supply chain logistics through interactive role-playing carried out in a simulated supply chain system, said model comprising:
(a) a notional, predefined geographic region where product is manufactured and distributed;
(b) a first participant role-playing a notional customer located within said geographic region, said customer initiating at least one product order cycle in the supply chain system;
(c) a second participant role-playing a notional manufacturer who assembles raw components to create product ordered by said customer, said manufacturer being located a predefined distance from said customer within said geographic region;
(d) a third participant role-playing a notional distributor who transports the assembled product from said manufacturer to said customer, transportation time being simulated based on a predefined time and distance scale; and
(e) a timer for calculating order cycle delivery time beginning from placement of the product order to receipt by said customer of the assembled product.

2. A supply chain logistics model according to claim 1, wherein customer orders are created randomly by spinning a customer order entry gauge to determine the quantity and type of product ordered.

3. A supply chain logistics model according to claim 2, wherein said notional geographic region is divided into a plurality of notional sub-regions.

4. A supply chain logistics model according to claim 3, and comprising fourth and fifth workshop participants role-playing respective notional sales managers for said sub-regions.

5. A supply chain logistics model according to claim 4, wherein each of said sales managers is responsible for accepting customer orders and scheduling product distribution.

6. A supply chain logistics model according to claim 5, and comprising a sixth workshop participant role-playing a notional distribution warehouse manager who manages a notional distribution warehouse.

7. A supply chain logistics model according to claim 6, wherein said distribution warehouse manager is responsible for ensuring sufficient quantity of finished good product in the distribution warehouse.

8. A supply chain logistics model according to claim 7, wherein said manufacturer comprises a notional plant manager who manages a notional product manufacturing plant.

9. A supply chain logistics model according to claim 8, wherein said plant manager is responsible for obtaining raw components to assemble product, and for requesting transportation services from said distributor.

10. A supply chain logistics model according to claim 9, and comprising a seventh workshop participant role-playing a notional supplier who supplies raw components to said manufacturing plant.

11. A supply chain logistics model according to claim 10, and comprising an eighth workshop participant role-playing a notional consolidator who creates part kits for delivery downstream to said manufacturing plant.

12. A supply chain logistics model according to claim 11, wherein said distributor comprises a notional truck driver who delivers finished product from said manufacturing plant to said customer.

13. A supply chain logistics model according to claim 12, and comprising a ninth workshop participant role-playing another notional truck driver who delivers raw components from said supplier to said manufacturing plant.

14. A supply chain logistics model according to claim 13, and comprising a tenth workshop participant role-playing another notional truck drive who delivers part kits from said consolidator to said manufacturing plant.

15. A supply chain logistics model according to claim 1, and comprising a supply chain logistics financial model for collecting and analyzing data to determine performance results of the simulated order cycle across the entire supply chain system.

16. A method of educating and training a number of workshop participants in supply chain logistics through interactive role-playing carried out in a simulated supply chain system, said method comprising the steps of:
(a) defining a notional geographic region where product is manufactured and distributed;
(b) role-playing a notional customer located within said geographic region, said customer initiating at least one product order cycle in the supply chain system;
(c) role-playing a notional manufacturer who assembles raw components to create product ordered by said customer, the manufacturer being located a predefined distance from the customer within the geographic region;
(d) role-playing a notional distributor who transports the assembled product from the manufacturer to the customer, transportation time being simulated based on a predefined time and distance scale; and
(e) calculating order cycle delivery time beginning from placement of the product order to receipt by the customer of the assembled product.

17. A method according to claim 16, and comprising the step of creating customer orders randomly by spinning a customer order entry gauge to determine the quantity and type of product ordered.

18. A method according to claim 17, and comprising the step of role-playing a notional sales manager who accepts customer orders and schedules product distribution.

19. A method according to claim 18, and comprising the step of role-playing a notional distribution warehouse manager who manages a notional distribution warehouse.

20. A method according to claim 16, and comprising the step of collecting and analyzing data to determine performance results of the simulated order cycle across the entire supply chain system.
